(19) United States
(12) Patent Application Publication
(10) Pub. No.: US 2026/0029114 A1
(43) Pub. Date: Jan. 29, 2026

(54) CORRUGATED METAL CEILING SHROUD FOR CAN LIGHTING AND CEILING FANS

(71) Applicant: Daniel E. Barry, Bertram, TX (US)

(72) Inventor: Daniel E. Barry, Bertram, TX (US)

(21) Appl. No.: 19/349,553

(22) Filed: Oct. 3, 2025

Related U.S. Application Data
(63) Continuation of application No. 18/435,003, filed on Feb. 7, 2024.
(60) Provisional application No. 63/446,319, filed on Feb. 16, 2023.

(51) Int. Cl. F21V 21/03; F21S 8/02; H02G 3/08; H02G 3/20

(52) U.S. Cl. CPC F21V 21/03; F21S 8/026; H02G 3/081; H02G 3/20

(57) ABSTRACT

The present invention is a plastic shroud for corrugated metal ceilings, which hides the gaps in the ceiling between a can light and conforms to the peaks and valleys of a corrugated metal ceiling. The core components of the invention are ABS or injection molded plastic, which, generally speaking, are configured as follows: {one solid piece that can be easily installed with the existing mounting hardware of a can light}. The invention can be used on different corrugated metal ceilings or walls for many different types of applications such as can lighting, ceiling fans, or other round objects. Furthermore, it should be noted that it requires no additional hardware and installs in seconds with existing can light hardware from most can light manufacturers.

### CROSS REFERENCE TO RELATED APPLICATIONS

This application is a continuation of U.S. Non-Provisional application Ser. No. 18/435,003, filed Feb. 7, 2024, titled “Corrugated Metal Ceiling Shroud for Can Lighting and Ceiling Fans,” which claims priority to, and the benefit of U.S. Provisional Application No. 63/446,319, filed Feb. 16, 2023, titled “Corrugated Metal Ceiling Shroud for Can Lighting and Ceiling Fans,” the disclosures of which are incorporated herein by reference in their entirety.

### TECHNICAL FIELD

The invention relates generally to corrugated metal ceiling shroud for can lighting and ceiling fans.

### BACKGROUND

Currently, there are a number of solutions for {metal ceiling lighting}. Some of these solutions attempt to fill the gaps in metal celling corrugated gaps and are a professional solution, but these solutions fail to meet the needs of the industry because they don't fill the gaps correctly. Other solutions attempt to most solutions leave gaps and look poor in appearance, but these solutions are similarly unable to meet the needs of the industry because it does not fill the gaps in the metal ceiling. Still, other solutions seek to fill the gaps in the corrugated metal ceiling, but these solutions also fail to meet industry needs because they leave gaps.

### SUMMARY OF THE INVENTION

It would be desirable to have a corrugated metal ceilings such as the kind found inside many metal buildings which/that hides and seal the gaps and fills the peaks and valleys of corrugated metal ceilings. Furthermore, it would be desirable to have an aesthetic appeal as these: dress up metal ceiling lighting. Still, further, it would also be desirable to have a safe way to hide wires and seal gaps around water-prone areas such as baths, showers or other wet areas. The disclosed device advantageously fills these needs and addresses the aforementioned deficiencies by providing a safe and utilitarian way to fill the gaps in metal roofing around can lighting.

Disclosed is a corrugated metal lighting shroud, which is made up of the following components: ABS or rotomolded plastic housing. These components are ABS or Rotomolded Plastic Shroud Housing as follows: one piece design. The associated method Is made up of the following steps. Mounts with Lighting Bracket Hardware.

The device may also have one or more of the following: {N/A}.

The disclosed device is unique when compared with other known devices and solutions because it provides: (1) Ascetically pleasing; (2) Utilitarian; and (3) Safety Minded (Hides the Electrical Wiring).

The disclosed device is unique in that it is structurally different from other known devices or solutions. More specifically, the device is unique due to the presence of (1) Ridges and Valleys to Fill the gaps in the ceiling; (2) round fixture that fits the can light well; and (3) a way to hide wiring and is safety minded.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The Corrugated Metal Ceiling Shroud for Can Lighting and Ceiling Fans may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1.—Top View of Metal Ceiling Light Shroud

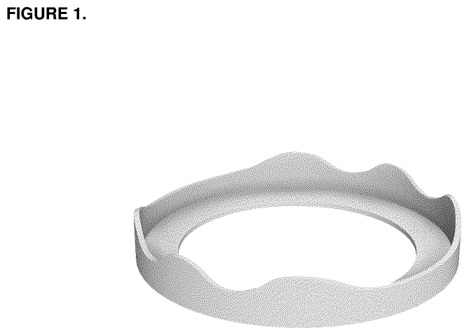

FIG. 2.—Bottom View of Metal Ceiling Light Shroud

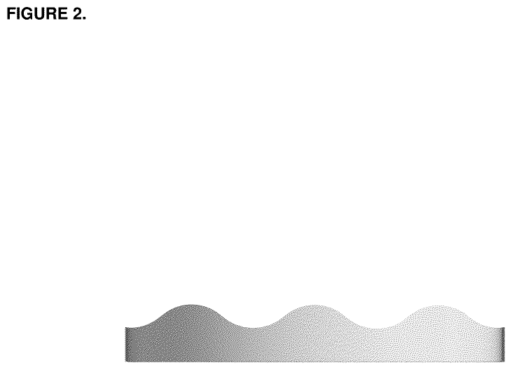

FIG. 3.—Light Mounted with Shroud on Corrugated Metal Ceiling

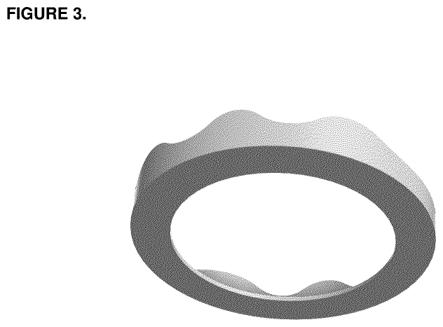

FIG. 4.—Side View of Metal Ceiling Light Shroud

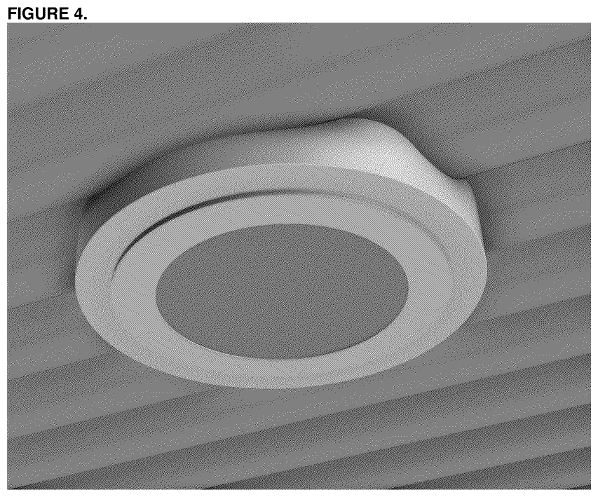

### DETAILED DESCRIPTION

The present invention is directed to corrugated metal ceiling shroud for can lighting and ceiling fans.

In its most complete version, the device is made up of the following components ABS or Rotomolded Plastic. These components are one piece ABS plastic shroud. It should further be noted that: shroud is mounted with lighting hardware supplied by can lighting manufacturer.

Top view of shroud showcasing how it mounts to the ceiling, covering the ridges (peaks and valleys) of metal ceiling.

Bottom view of shroud showing how it would mount without a can light added.

Completely installed metal building shroud showing installed with the can light (Light NOT included).

Side view on the shroud showcases how it covers the gaps in the metal ceiling and fills the peaks and valleys.

This application is a continuation of U.S. Non-Provisional application Ser. No. 18/435,003, filed Feb. 7, 2024, titled “Corrugated Metal Ceiling Shroud for Can Lighting and Ceiling Fans,” which claims priority to, and the benefit of U.S. Provisional Application No. 63/446,319, filed Feb. 16, 2023, titled “Corrugated Metal Ceiling Shroud for Can Lighting and Ceiling Fans,” the disclosures of which are incorporated herein by reference in their entirety.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

That is claimed is:

1. An electrical plate cover for a corrugated mounting surface, the plate cover comprising:
a plate cover body have a top face cover and a bottom face, the bottom face to be positioned adjacent an electrical fixture when the electrical plate cover is positioned thereon;
a plurality of peaks and a plurality of valleys extending around lower peripheries of the bottom face of the plate cover body so that each of the respective plurality of peaks and each of the respective plurality of valleys fills gaps in the corrugated mounting surface when positioned on the corrugated mounting surface; and
one or more openings extending through the plate cover body from the top face cover to the bottom face, the one or more openings to provide exposure access to the electrical fixture.

2. The electrical plate cover as defined in claim 1, wherein the electrical fixture comprises an electrical light fixture.

3. The electrical plate cover as defined in claim 1, wherein the plate cover body and the plurality of peaks and valleys comprise a substantially rigid material.

4. The electrical plate cover as defined in claim 3, wherein each of the plurality of peaks of the electrical plate cover comprises a ridge to abut against a corresponding valley in the corrugated mounting surface when positioned to mount on the corrugated mounting surface, and wherein each of the plurality of valleys of the electrical plate cover abuts against a corresponding peak in the corrugated mounting surface when positioned to mount on the corrugated mounting surface.

5. The electrical plate cover as defined in claim 4, wherein the plate cover body has a substantially round shape and is configured to receive one or more of: a can light well or a ceiling fan, wherein the electrical plate cover comprises one or more of: a metal material, an ABS plastic material, or a rotomolded plastic, wherein the plate cover body comprises a shroud body, and wherein the shroud body has a depth so as to hide wiring positioned the metal ceiling shroud is positioned on the corrugated mounting surface.

6. A ceiling shroud for a corrugated mounting surface, the plate cover comprising:
a shroud body have a top face cover and a bottom face, the bottom face to be positioned adjacent an electrical fixture when the ceiling shroud is positioned thereon;
one or more peaks and one or more valleys extending around lower peripheries of the bottom face of the shroud body so that the respective one or more peaks and the one or more valleys fill gaps in the corrugated mounting surface when positioned on the corrugated mounting surface; and
one or more openings extending through the shroud body from the top face cover to the bottom face, the one or more openings to provide exposure access to the electrical fixture.

7. The ceiling shroud as defined in claim 6, wherein the electrical fixture comprises an electrical light fixture.

8. The ceiling shroud as defined in claim 6, wherein the one or more peaks and the one or more valleys comprises a plurality of peaks and valleys substantially surrounding the one or more openings, and wherein the plate cover body and the plurality of peaks and valleys comprise a substantially rigid material.

9. The ceiling shroud as defined in claim 8, wherein each of the plurality of peaks of the ceiling shroud comprises a ridge to abut against a corresponding valley in the corrugated mounting surface when positioned to mount on the corrugated mounting surface, and wherein each of the plurality of valleys of the ceiling shroud abuts against a corresponding peak in the corrugated mounting surface when positioned to mount on the corrugated mounting surface.

10. The ceiling shroud as defined in claim 9, wherein the shroud body has a substantially round shape and is configured to receive one or more of: a can light well or a ceiling fan, wherein the shroud body comprises metal material, and wherein the ceiling shroud body has a depth so as to hide wiring when the ceiling shroud is positioned on the corrugated mounting surface.
